(19) United States
(12) Patent Application Publication
(10) Pub. No.: US 2026/0016402 A1
(43) Pub. Date: Jan. 15, 2026

(54) OPTICAL OBSERVATION APPARATUS AND IMAGING METHOD USED IN OPTICAL OBSERVATION APPARATUS

(71) Applicant: KATAOKA CORPORATION, Kyoto (JP)

(72) Inventors: Junichi MATSUMOTO, Kyoto (JP); Yukako KUSAKA, Kyoto (JP)

(73) Assignee: KATAOKA CORPORATION, Kyoto (JP)

(21) Appl. No.: 19/085,124

(22) Filed: Mar. 20, 2025

(30) Foreign Application Priority Data
Jul. 12, 2024 (JP) 2024-112586

(51) Int. Cl. G01N 21/33; G01N 21/25; G01N 21/64

(52) U.S. Cl. CPC G01N 21/33; G01N 21/255; G01N 21/6458; G01N 2021/6482; G01N 2201/0686

(57) ABSTRACT

An optical observation apparatus of the present disclosure includes: a stage on which a sample containing a cell can be placed, a light source configured to irradiate the sample with ultraviolet light from at least two directions, an imaging optical system configured to an image of observation light emitted from the sample due to the ultraviolet light as an observation image, and an imager configured to take the observation image that has been formed using an image sensor.

### RELATED APPLICATION

This application claims priority from Japanese Patent Application No. 2024-112586 filed on Jul. 12, 2024. The entire disclosure of this Japanese patent application is herein incorporated by reference in its entirety.

### FIELD OF INVENTION

The present disclosure relates to an optical observation apparatus and an imaging method used in the optical observation apparatus.

### DESCRIPTION OF THE RELATED ART

As a method for observing biological tissues, a method that uses ultraviolet light to excite a surface of a sample for observation (Microscopy with ultraviolet surface excitation (MUSE)) has been developed. As illustrated in FIG. 11A, in MUSE, a sample S is stained with a fluorescent dye that can be excited by ultraviolet light UV, and the acquired sample S is irradiated with the ultraviolet light UV at an oblique angle. Then, fluorescence FL emitted from the sample S is observed by a camera 95 installed in a direction orthogonal (perpendicular) to the surface on which the sample S is arranged (placed) (Patent Literature 1). It is known that, due to the short wavelength of the ultraviolet light UV, irradiating the sample S with the ultraviolet light UV at an oblique angle enables observation of a surface layer of the sample S in MUSE.

### CITATION LIST

### Patent Literature

Patent Literature 1: P 2017-534846 A

### BRIEF SUMMARY OF INVENTION

In MUSE, the surface of the sample can be observed after being stained with a fluorescent dye. Hence, compared with a general method for observing biological tissues in which the tissues are histologically stained with HE staining or the like, and the stained biological tissues are observed, MUSE is expected to enable faster diagnosis of pathological tissues, and the like.

However, as illustrated in FIG. 11B, there are irregularities on the surface of the sample. Accordingly, the present inventors have found that, in an observation image G acquired through MUSE, shadows GS are generated caused by the irregularities on the surface of the sample S (tissue surface or cell surface) in addition to cell observation images GC, leading to an issue in which information about the tissues or cells is lost in the portions of the shadows GS. Furthermore, the observation image G acquired through MUSE, which differs from an observation image acquired through a general method for observing biological tissues due to the above-mentioned issue, may not be applicable to existing methods of histological diagnosis.

Hence, the present disclosure is intended to provide an optical observation apparatus and an imaging method used in the optical observation apparatus in which generation of shadows caused by irregularities on a sample are suppressed, for observation of the sample containing cells using ultraviolet light.

The present disclosure provides an optical observation apparatus including:
a placement unit configured to place a sample containing a cell,
a light source configured to irradiate the sample with ultraviolet light from at least two directions,
an imaging optical system configured to form an image of observation light emitted from the sample due to the ultraviolet light as an observation image, and
an imaging unit configured to take the observation image using an image sensor.

The present disclosure provides an imaging method used in an optical observation apparatus that includes a placement unit, a light source, an imaging optical system, and an imaging unit, the imaging method including:
irradiating a sample containing a cell that is placed on the placement unit with ultraviolet light projected from the light source from at least two directions,
forming an image of observation light emitted from the sample due to the ultraviolet light as an observation image using the imaging optical system, and
taking the observation image using an image sensor of the imaging unit

According to the present disclosure, it is capable of providing the optical observation apparatus and the imaging method used in the optical observation apparatus in which generation of shadows caused by the irregularities on the sample are suppressed, for observation of the sample containing cells using ultraviolet light.

### BRIEF DESCRIPTION OF DRAWINGS

FIGS. 1A and 1B are schematic cross-sectional views illustrating an example of an optical observation apparatus according to a first embodiment.

FIG. 2 is a flowchart illustrating an example of an imaging method according to the first embodiment.

FIGS. 3A and 3B are schematic cross-sectional views illustrating an example of an optical observation apparatus according to a first modification.

FIGS. 4A and 4B are schematic cross-sectional views illustrating an example of an optical observation apparatus according to a second modification.

FIGS. 5A and 5B are schematic cross-sectional views illustrating an example of an optical observation apparatus according to a third modification.

FIGS. 6A and 6B are schematic cross-sectional views illustrating an example of an optical observation apparatus according to a fourth modification.

FIGS. 7A and 7D are schematic cross-sectional views illustrating an example of an optical observation apparatus according to a second embodiment. FIG. 7E is a schematic view of an observation image of a sample.

FIG. 8 is a block diagram illustrating an example of a control unit of the optical observation apparatus according to the second embodiment.

FIG. 9 is a flowchart illustrating an example of an imaging method according to the second embodiment.

FIG. 10 is a schematic cross-sectional view illustrating an example of an optical observation apparatus according to a fifth modification.

FIG. 11A is schematic cross-sectional view illustrating an example of an observation apparatus in MUSE. FIG. 11B is a schematic view and a schematic cross-sectional view of an observation image of a sample.

### DETAILED DESCRIPTION OF THE INVENTION

The term “optical axis direction” as used herein means the direction of the optical axis (symmetrical axis) in an imaging optical system, also referred to as the “Z-axis direction”. The optical axis direction can also refer to, for example, a direction orthogonal (perpendicular) to the surface on which a sample is arranged (placed). In addition, in the present disclosure, the term “X-axis direction” refers to one direction on a plane (XY plane) orthogonal to the optical axis direction, and the term “Y-axis direction” means a direction orthogonal (perpendicular) to the X-axis direction on the XY plane.

The term “observation” as used herein means observation of a sample, which may be, for example, observation with or without imaging.

The term “cell” as used herein means a cell or a composition comprising a cell. The cell may be, for example, a cell, a cell aggregate composed of cells, a tissue, an organ, or the like. The cell may be, for example, a cultured cell or a cell isolated from a living body. The origin of the cell is, for example, an animal such as a human or a non-human animal. Examples of the non-human animal include a monkey, a horse, a pig, a cow, a sheep, a dog, a cat, a rat, a mouse, and the like. The sample containing the cells may, for example, be an organ, a tissue, or a part thereof that is surgically removed or excised from the animal. Examples of the sample containing the cells include, for example, lymph, blood, plasma, serum, saliva, tear fluid, gastric juice, sputum, urine, pleural fluid, ascites fluid, a biopsy sample, a punctured cell sample (for needle cytology), and the like. Examples of the tissue or organ include, for example, esophagus, stomach, small intestine, large intestine, duodenum, rectum, liver, pancreas, gallbladder, urinary bladder, kidney, prostate, uterus, ovary, breast, lung, bronchus, thyroid gland, parathyroid gland, adrenal gland, skin, brain, spinal cord, bone, muscle, soft tissue such as smooth muscle, bone marrow, lymph node, peritoneum, diaphragm, and the like.

The sample containing the cells may be, for example, a sample subjected to fixation treatment with formalin, paraformaldehyde, and the like, and/or cell membrane permeabilization treatment using surfactants such as saponin.

For example, the sample containing the cells may be housed in a cell culture vessel such as a dish, plate, or flask (cell culture flask) or placed on a substrate such as glass, plastic, or a slide.

The term “ultraviolet light” as used herein means light having a shorter wavelength than visible light. Specifically, the wavelength of the ultraviolet light is, for example, 200 to 400 nm or 240 to 300 nm.

The term “fluorescent dye” as used herein means, for example, a dye that is brought to an excited state by excitation light to emit fluorescence when returning to its ground state. Examples of the fluorescent dye include a fluorescent dye excited by ultraviolet light, that is, a fluorescent dye with an absorption range in the wavelength region of ultraviolet light. As specific examples, the fluorescent dye excited by ultraviolet light includes eosin dyes (such as eosin B), toluidine blue O, methylene blue, DAPI, Acridine Orange, DRAQ 5, Hoechst 33342, Hoechst 33528, calcein-AM, propidium iodide, Nile Blue, Nile Red, Oil Red O, Congo Red, Fast Green FCF, DiI, DIO, DID, TOTO (registered trademark) dyes, YO-PRO (registered trademark) dyes, Neutral Red, Nuclear Fast Red, Pyronine Y, acid fuchsin, astrazon-family dyes, MitoTracker, mitochondrial dyes, LysoTracker dyes, lysosomal dyes, safranin dyes, thioflavin dyes, fluorescent phalloidins, terbium chloride (TbCl₃), nucleobases, aromatic amines, dopamine, serotonin, and the like.

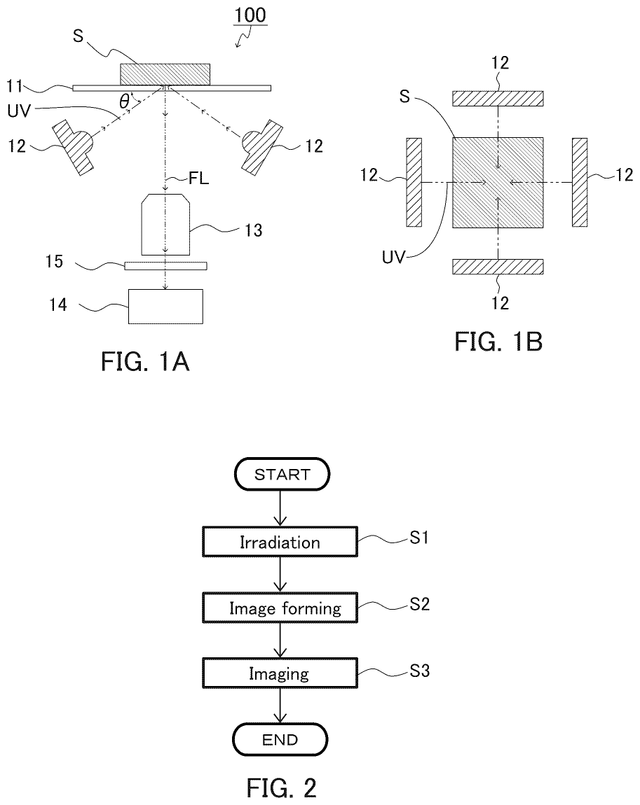

Hereinafter, the optical observation apparatus according to the present disclosure will be described in detail with reference to the drawings. The present disclosure, however, is not limited by the following description. Note that in FIGS. 1A to 10 below, the same parts are denoted by the same reference numerals, and the description thereof may be omitted. Furthermore, in the drawings, the structure of each component may be illustrated in a simplified manner as appropriate for convenience of description, and the size, the ratio, and the like of each component may be schematically illustrated and different from actual ones. Unless otherwise stated, descriptions regarding the respective embodiments are applicable to each other.

### First Embodiment

A first embodiment relates to an optical observation apparatus and an imaging method of the present disclosure.

The present embodiment is an example of a first optical observation apparatus. FIGS. 1A and 1B are schematic views illustrating a configuration of an optical observation apparatus 100 of the first embodiment. As illustrated in FIG. 1A, the optical observation apparatus 100 includes, as its main components, a stage 11 which serves as a placement unit, light sources 12, an objective lens 13 which serves as an imaging optical system, a camera 14 which serves as an imaging unit including an image sensor, and a bandpass filter 15 which serves as a filter unit. As illustrated in FIG. 1A, the objective lens 13, the bandpass filter 15, and the camera 14 are arranged in this order, from the stage 11 side, along the optical axis. In addition, as illustrated in FIG. 1B, the optical observation apparatus 100 includes four light sources 12, which are arranged on the same arc centered around the optical axis of the objective lens 13, at substantially 90-degree intervals. In FIGS. 1A and 1B, the dash-dotted line indicates an optical path of observation light including ultraviolet light UV projected from the light sources 12 and fluorescence FL emitted from a sample S.

On the stage 11, the sample S containing the cells, which is a configuration external to the optical observation apparatus 100, is placed. The sample S is stained with a fluorescent dye capable of staining cells, as described below. For the stage 11, any configuration on which the sample S can be placed may be employed. As a specific example, a configuration of a placement unit in a known optical observation apparatus can be used, for the placement unit. Examples of the optical observation apparatus include a bright-field microscope, a stereoscopic microscope, a phase-contrast microscope, a differential interference microscope, a polarizing microscope, a fluorescence microscope, a confocal laser microscope, a total internal reflection fluorescence microscope, a Raman microscope, and the like, and preferably, the apparatus is a phase-contrast microscope. In the stage 11, the placement region for the sample S is configured so that the sample S can be observed through the objective lens 13 arranged below the stage 11. The placement region for the sample S may be formed of a translucent material such as glass, quartz, plastic or resin, or a through hole may be formed in a part thereof.

The light sources 12 irradiate the sample S placed on the stage 11, more specifically, an observation position (around the optical axis) of the objective lens 13, with the ultraviolet light UV. The optical observation apparatus 100 includes, as the light sources 12, four rod-shaped light sources, which are arranged on the same arc centered around the optical axis of the objective lens 13, at substantially 90-degree intervals. This arrangement enables the light sources 12 to irradiate the sample S with the ultraviolet light UV from four different directions. In the optical observation apparatus 100, the light sources 12 are arranged between the stage 11 and the objective lens 13 in the optical axis direction. The light sources 12 may be, for example, a light emitting diode (LED) (any wavelength ranging from 200 to 400 nm), a laser light source (any wavelength ranging from 200 to 400 nm), a high-pressure mercury UV lamp (main wavelength: 365 nm), a metal halide UV lamp (continuous wavelength ranging from 200 to 400 nm), a low-pressure mercury UV lamp (254 nm), an ozone lamp (185 nm and 254 nm), a xenon light source (continuous wavelength ranging from 200 to 400 nm), and a deuterium lamp (continuous wavelength ranging from 200 to 400 nm).

Although the number of the light sources 12 is four in the optical observation apparatus 100, the light source only needs to be capable of projecting ultraviolet light from at least two directions. The number of light sources is not limited to particular quantities, and may be one or more. In a case where there are two or more light sources 12, the light sources are preferably arranged on the same arc centered around the optical axis of the objective lens 13 (imaging optical system), and is preferably arranged on the same arc at substantially the same intervals in the circumferential direction (peripheral direction), for example.

In the optical observation apparatus 100 of the first embodiment, the sample S is directly irradiated with the ultraviolet light UV projected from the light sources 12. However, the optical observation apparatus 100 of the present disclosure may include, in addition to such a configuration, an illumination optical system that guides the ultraviolet light UV from the light sources 12 to the sample S, as described below. For the illumination optical system, a configuration of an illumination optical system in the above-described optical observation apparatus can be employed, for example.

The ultraviolet light UV projected from the light sources 12 is incident on the sample S at any angle. It is preferable that the ultraviolet light UV be projected so that the optical axis of the ultraviolet light UV and the surface on which the stage 11 is placed intersect at an acute angle, that is, the angle of incidence θ is 90 degrees or less. The angle of incidence θ may be, for example, 10 to 50 degrees. When the angle of incidence θ is 90 degrees or less, the optical observation apparatus of the present disclosure is capable of irradiating even recessed portions on the sample S with the ultraviolet light UV by irradiating the sample S with the ultraviolet light UV from two directions. This can suppress generation of shadows caused by irregularities on the surface of the sample S.

The objective lens 13 forms, as an observation image, an image of the observation light including the fluorescence FL of the sample S onto the camera 14 which serves as the image sensor. More specifically, the objective lens 13 forms, as an observation image, an image of the observation light of the cells in the sample S onto the image sensor of the camera 14. Thus, the optical observation apparatus 100 enables observation and imaging of the cells in the sample S. Although the imaging optical system is included as the objective lens 13 in the optical observation apparatus 100, the imaging optical system only needs to be capable of forming an observation image of the sample S. For the imaging optical system, a configuration of an imaging optical system in the above-described optical observation apparatus can be employed, for example.

Although the number of the objective lenses 13 is one in the optical observation apparatus 100, the number of the objective lenses may be two or more. In this case, the magnification of each objective lens 13 may be the same or different.

Although the objective lens 13 is arranged below the sample S in the optical observation apparatus 100, the objective lens 13 may be arranged above the sample S. In this case, the light sources 12, the camera 14, and the bandpass filter 15 in the optical observation apparatus 100 are also arranged above the sample S.

The camera 14 is capable of taking the observation image of the sample S, and more specifically, the camera 14 is configured to be capable of taking the observation image of the cells in the sample S. Although in the optical observation apparatus 100, the camera 14 including the image sensor is used as the imaging unit, any configuration capable of taking the observation image of the sample S can be employed. For example, a known image sensor can be used for the image sensor, and specific examples thereof include devices such as a charge-coupled device (CCD), a complementary metal oxide semiconductor (CMOS). Accordingly, for the imaging unit, a camera or the like including any of these image sensors can be employed, for example.

The camera 14 is configured to take the observation image of the sample S upon receiving an imaging trigger signal input by a user, for example. A period of one imaging time (exposure time) of the camera 14 can be set as appropriate according to, for example, the brightness of the sample S.

The bandpass filter 15 changes the wavelength region of the observation light including the fluorescence FL transmitted through the objective lens 13. Specifically, the bandpass filter 15 has optical properties capable of extracting the wavelength region of the fluorescence FL of the fluorescent dye used for staining the sample S in the observation light. That is, the bandpass filter 15 transmits light within the wavelength region of the fluorescence FL and does not transmit or attenuates light of the wavelength region of noise, which is other than the fluorescence FL. The optical observation apparatus 100 can reduce noise in the observation light by including the bandpass filter 15, and thus can take the observation image with reduced noise. The wavelength region of the observation light varies according to a fluorescent dye that is used for staining the sample S, for example, and may be, for example, 400 to 600 nm. The wavelength region of the fluorescent FL varies according to a fluorescent dye that is used for staining the sample S, for example. As a specific example, when the fluorescent dye is Hoechst (for example, Hoechst 33342, Hoechst 33528), the wavelength region of the fluorescence FL is, for example, 400 to 450 nm. When the fluorescent dye is terbium chloride, the wavelength region of the fluorescence FL is, for example, 520 to 550 nm. Note that the optical observation apparatus 100 of the first embodiment may or may not include the bandpass filter 15, which is an optional component. Furthermore, in the optical observation apparatus of the present disclosure, a long wavelength transmission filter, a short wavelength transmission filter, a superconducting transition-edge sensor, or the like may be used for the filter unit, instead of the bandpass filter 15.

In the optical observation apparatus 100, the observation image is formed on the camera 14, and is taken by the camera 14. The acquired image may then be displayed on a display device external to the apparatus. In addition to displaying the image on the display device, the optical observation apparatus 100 may relay the image acquired by the objective lens 13 (primary image) onto an eyepiece, through which a user of the optical observation apparatus 100 observes. In this case, the optical observation apparatus 100 includes, for example, an eyepiece and a relay optical system that relays the primary image onto the eyepiece. For the relay optical system and the eyepiece, a configuration of a relay optical system and an eyepiece in the above-described optical observation apparatus can be used, for example. Specific examples of the display device will be described below.

In addition, the camera 14 which serves as the imaging optical system may transmit the taken image to the arithmetic unit such as a computer (for example, a control unit as described below). In this case, it is preferable that the camera 14 associate, with the taken image, an imaging position of the image (for example, coordinates such as XYZ coordinates) and transmit it to the arithmetic unit.

Next, an imaging method of the first embodiment using the optical observation apparatus 100 of the first embodiment will be described.

FIG. 2 is a flowchart illustrating the imaging method of the first embodiment. As illustrated in FIG. 2, the imaging method of the first embodiment includes step S1 (irradiation), step S2 (image forming), and step S3 (imaging).

First, prior to step S1, the sample S to be placed on the stage 11 is prepared.

Specifically, the cells to be detected by the optical observation apparatus 100 in the sample S is stained with a fluorescent dye in advance. Fluorescent staining of the cells can be performed by known staining methods, and can be performed as appropriate according to the type of the cells to be detected and the type of molecules in the cells. For the fluorescent staining, specific staining may be performed using, for example, a fluorescent dye-labeled antibody, nucleic acid molecule such as an aptamer, ligand, or receptor. The sample S stained with the fluorescent dye is then placed on the stage 11 of the optical observation apparatus 100.

Next, in step S1, the sample S placed on the stage 11 is irradiated with the ultraviolet light UV projected from the light sources 12. Specifically, in step S1, the sample S containing the cells placed on the stage 11 is directly irradiated with the ultraviolet light UV from the light sources 12. At this time, in step S1, the ultraviolet light UV is incident on the sample S from four directions. When the sample S is irradiated with the ultraviolet light UV, the ultraviolet light UV excites the fluorescent dye on the sample S to an excited state, and the fluorescence FL is emitted when the fluorescent dye returns to its ground state.

In step S2, an image of the observation light including the fluorescence FL emitted from the sample S due to the ultraviolet light UV in step S1 is formed onto the image sensor of the camera 14 by the objective lens 13. Specifically, in step S2, of the observation light including the fluorescence FL, the observation light in the optical axis direction is transmitted through the objective lens 13. At this time, the objective lens 13 forms an image of the observation light such that the observation image is formed onto the image sensor of the camera 14. The observation light transmitted through the objective lens 13 comes into contact with the bandpass filter 15, in which the light within the wavelength region of the fluorescence FL is transmitted, while the light having the wavelength region other than the fluorescence FL is attenuated. Then, an image of the observation light transmitted through the bandpass filter 15 is formed onto the image sensor of the camera 14.

In step S3, the observation image that has been formed is taken by the image sensor of the camera 14, allowing the observation image of the sample S to be taken.

The imaging method of the first embodiment is then completed.

In the optical observation apparatus 100 of the first embodiment, the four light sources 12 are arranged on the same arc centered around the optical axis of the objective lens 13, at 90-degree intervals. This arrangement enables the light sources 12 to irradiate the sample S with the ultraviolet light UV from four different directions. Thus, the optical observation apparatus 100 is configured so that even when the ultraviolet light UV projected from one of the light sources 12 fails to reach recessed portions of irregularities on the surface of the sample S, the ultraviolet light UV projected from any of the other three light sources 12 can easily reach the recessed portions. This configuration enables the optical observation apparatus 100 to irradiate, with the ultraviolet light UV, a wider area in the recessed portions on the sample S, compared with MUSE, and to cause the cells even in the recessed portions to emit the observation light including the fluorescence FL. Therefore, the optical observation apparatus 100 of the first embodiment can suppress generation of shadows caused by the irregularities on the sample S.

### Modification of First Embodiment

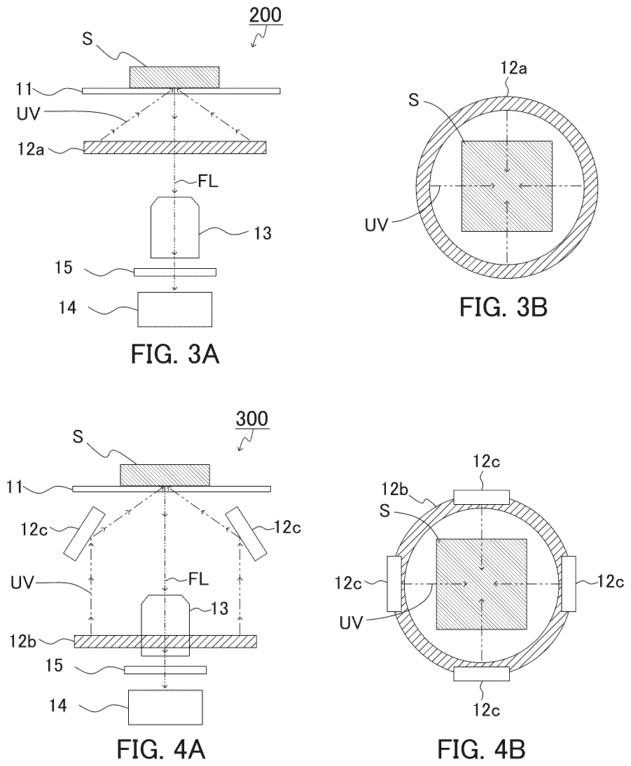

The optical observation apparatus of the present disclosure is not limited to the mode of the first embodiment, and can be modified in various ways. For example, an example of a case where, in the optical observation apparatus 100 of first embodiment, the rod-shaped light sources 12 are arranged at four locations on the arc centered around the optical axis of the objective lens 13 and the sample S is irradiated from the light sources 12 at four locations is illustrated. However, the optical observation apparatus of the present disclosure is not limited to the example, and other light sources 12 and, optionally, the illumination optical system that guides the ultraviolet light UV projected from the light sources 12 to the sample S may be used. Other examples of cases where other modes of light sources are used as the light sources 12 in the optical observation apparatus and of cases where other modes of light sources and the illumination optical systems are used as the light sources 12 in the optical observation apparatus are illustrated in FIGS. 3A to 6B.

### First Modification

FIGS. 3A and 3B are schematic views illustrating a configuration of an optical observation apparatus 200 of a first modification. As illustrated in FIGS. 3A and 3B, the optical observation apparatus 200 of the first modification includes, as a light source, an annular ring-shaped light source 12a, instead of the four rod-shaped light sources 12 in the optical observation apparatus 100 of the first embodiment, and is configured to irradiate the observation position of the objective lens 13 for the sample S with the ultraviolet light UV projected from the light source 12a. As illustrated in FIG. 3B, in the optical observation apparatus 200 of the first modification, the light source 12a is arranged so as to surround the observation position for the sample S in a circular shape, and the observation position for the sample S can be irradiated with the ultraviolet light UV from any position in the circular shape centered around the optical axis. Thus, the optical observation apparatus 200 is configured so that even when the ultraviolet light UV projected from the light source 12a in a certain direction fails to reach the recessed portions of the irregularities on the surface of the sample S, the ultraviolet light UV projected from other positions of the light source 12a can easily reach the recessed portions. This configuration enables the optical observation apparatus 200 to more efficiently irradiate, with the ultraviolet light UV, a wider area in the recessed portions on the sample S, compared with MUSE, and to cause the cells even in the recessed portions to emit the observation light including the fluorescence FL. Therefore, the optical observation apparatus 200 of the first modification can further suppress generation of shadows caused by the irregularities on the sample S.

### Second Modification

FIGS. 4A and 4B are schematic views illustrating a configuration of an optical observation apparatus 300 of a second modification. As illustrated in FIGS. 4A and 4B, the optical observation apparatus 300 of the second modification includes a light source 12b and mirrors 12c as an illumination optical system to guide the ultraviolet light UV projected from an annular light source 12b to the observation position of the objective lens 13 for the sample S, instead of the configuration of the optical observation apparatus 200 of the first modification. As illustrated in FIG. 4A, the light source 12b is arranged, in the optical axis direction, at substantially the same level as the objective lens 13 instead of between the stage 11 and the objective lens 13, and projects the ultraviolet light UV in the optical axis direction from the objective lens 13 toward the stage 11. As illustrated in FIG. 4B, the four mirrors 12c are arranged on the same arc centered around the optical axis of the objective lens 13 at 90-degree intervals. Accordingly, the ultraviolet light UV projected from the light source 12b is reflected from the four mirrors 12c, and the sample S can be irradiated from four different directions. Thus, the optical observation apparatus 300 is configured so that even when the ultraviolet light UV projected from the light source 12b and reflected from one of the mirrors 12c fails to reach the recessed portions of the irregularities on the surface of the sample S, the ultraviolet light UV reflected from any of the other three mirrors 12c can easily reach the recessed portions. This configuration enables the optical observation apparatus 300 to irradiate, with the ultraviolet light UV, a wider area in the recessed portions on the sample S, compared with MUSE, and to cause the cells even in the recessed portions to emit the observation light including the fluorescence FL. Therefore, the optical observation apparatus 300 of the second modification can suppress generation of shadows caused by the irregularities on the sample S. Although the rod-shaped mirrors 12c are used in the optical observation apparatus 300, the shape of the mirror in the optical observation apparatus of the present disclosure may be any shape that is capable of reflecting the ultraviolet light UV projected from the light source toward the observation position for the sample S, and may be annular ring-shaped, for example. In this case, by combining the annular mirror and an annular light source, a similar effect to the optical observation apparatus 200 of the first modification can be obtained.

### Third Modification

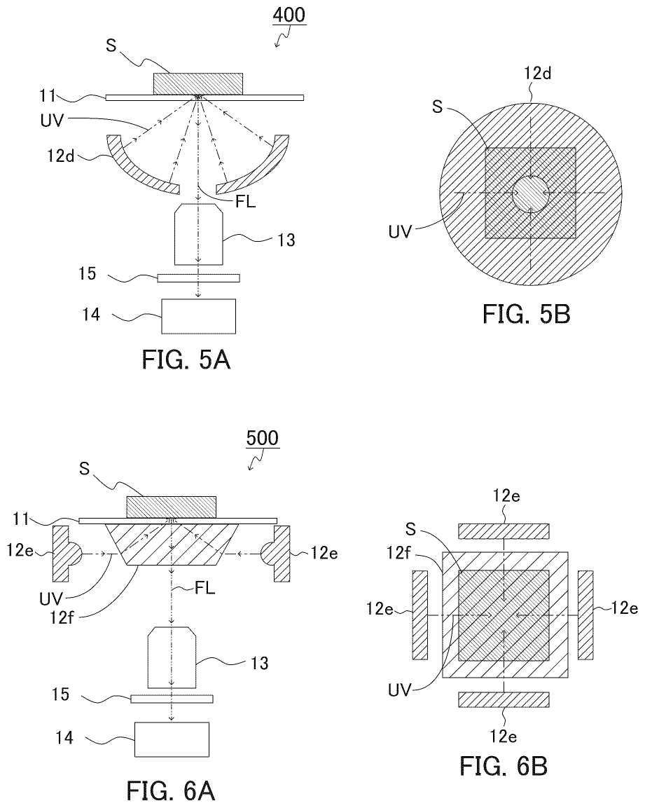

FIGS. 5A and 5B are schematic views illustrating a configuration of an optical observation apparatus 400 of a third modification. As illustrated in FIGS. 5A and 5B, the optical observation apparatus 400 of the third modification includes, instead of the four rod-shaped light sources 12 in the optical observation apparatus 100 of the first embodiment, a dome-shaped hemispherical light source 12d, which is arranged such that a first opening of the light source 12d faces the stage 11 in the optical axis direction. In addition, as illustrated in FIG. 5B, the dome-shaped light source 12d includes a second opening on the objective lens 13 side in the optical axis direction, as a light transmission portion that allows the fluorescence FL emitted from the sample S to pass through. As illustrated in FIGS. 5A and 5B, in the optical observation apparatus 400 of the third modification, the light source 12d is arranged so as to surround the observation position for the sample S hemispherically and the observation position for the sample S can be irradiated with the ultraviolet light UV from all directions. Furthermore, in the optical observation apparatus 400, the dome-shaped light source 12d can irradiate the observation position for the sample S with the ultraviolet light UV at different angles of incidence. Thus, the optical observation apparatus 400 is configured so that even when the ultraviolet light UV projected from the light source 12d in a certain direction at a certain angle of incidence fails to reach the recessed portions of the irregularities on the surface of the sample S, the ultraviolet light UV projected from other positions of the light source 12d can easily reach the recessed portions. This configuration enables the optical observation apparatus 400 to more efficiently irradiate, with the ultraviolet light UV, a wider area in the recessed portions on the sample S, compared with

MUSE, and to cause the cells even in the recessed portions to emit the observation light including the fluorescence FL. Therefore, the optical observation apparatus 400 of the third modification can further suppress generation of shadows caused by the irregularities on the sample S.

### Fourth Modification

FIGS. 6A and 6B are schematic views illustrating a configuration of an optical observation apparatus 500 of a fourth modification. As illustrated in FIGS. 6A and 6B, the optical observation apparatus 500 of the fourth modification includes four rod-shaped light sources 12e and a prism 12f, instead of the four rod-shaped light sources 12 in the optical observation apparatus 100 of the first embodiment. As illustrated in FIG. 6A, the four rod-shaped light sources 12e are arranged so that the projection direction of the ultraviolet light UV is parallel to the plane direction of the stage 11. As illustrated in FIG. 6A, the ultraviolet light UV projected in parallel from the light sources 12e is refracted by the prism 12f to be guided to the observation position for the sample S, and the sample S is irradiated therewith. Thus, the optical observation apparatus 500 is configured so that even when the ultraviolet light UV projected from one of the light sources 12e and refracted by the prism 12f fails to reach the recessed portions of the irregularities on the surface of the sample S, the ultraviolet light UV projected from any of the other three light sources 12e and refracted by the prism 12f can easily reach the recessed portions. This configuration enables the optical observation apparatus 500 to irradiate, with the ultraviolet light UV, a wider area in the recessed portions on the sample S, compared with MUSE, and to cause the cells even in the recessed portions to emit the observation light including the fluorescence FL. Therefore, the optical observation apparatus 500 of the fourth modification can suppress generation of shadows caused by the irregularities on the sample S. Furthermore, in the optical observation apparatus 500 of the fourth modification, even when the ultraviolet light UV is projected at an acute angle with respect to the sample S, no interference with the objective lens 13 occurs. Thus, according to the optical observation apparatus 500 of the fourth modification, stray light and interference caused by external light can be suppressed. Although the sample S is placed on the stage 11 in the optical observation apparatus 500 of the fourth modification, the optical observation apparatus of the present disclosure is not limited thereto. The optical observation apparatus of the present disclosure may not include the stage 11, and the sample S may be placed directly on the prism 12f.

### Second Embodiment

The present embodiment is another example of an optical observation apparatus and an imaging method of the present disclosure. In the optical observation apparatus 100 of the first embodiment, the number or irradiation direction of the light sources 12 is adjusted to suppress generation of shadows caused by the irregularities on the sample S. On the other hand, in the optical observation apparatus and the imaging method of the second embodiment, the positional relationship between the sample S and the light source is changed and the observation images taken for the same observation position of the sample S with different positional relationships are combined to suppress generation of shadows caused by the irregularities on the sample S.

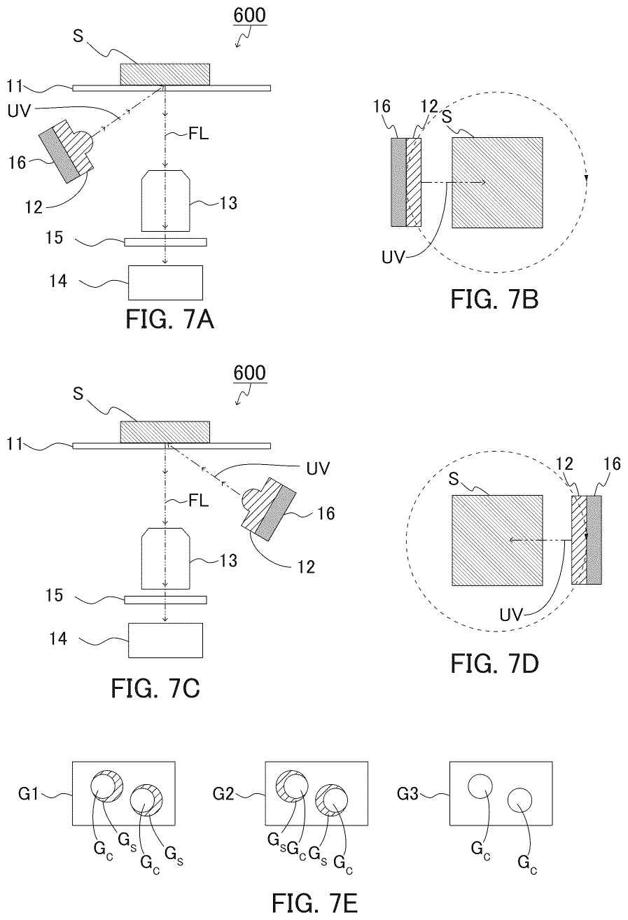

FIGS. 7A and 7D are schematic views illustrating a configuration of an optical observation apparatus 600 of the second embodiment. As illustrated in FIGS. 7A to 7D, the optical observation apparatus 600 includes a drive unit 16 in addition to the configuration of the optical observation apparatus 100 of the first embodiment. The optical observation apparatus 600 also includes a control unit 17 to be described below. As indicated in the dashed lines in FIGS. 7B and 7D, the drive unit 16 is capable of moving a light source 12 along a circular path centered around the optical axis of the objective lens 13.

The drive unit 16 is capable of moving the position of the light source 12 relative to the sample S. The movement and position of the drive unit 16 are controlled by the control unit 17 to be described below. For the drive unit 16, a combination of a rail and a carriage, a hollow motor, or a direct drive motor (DD motor), and the like can be used, for example.

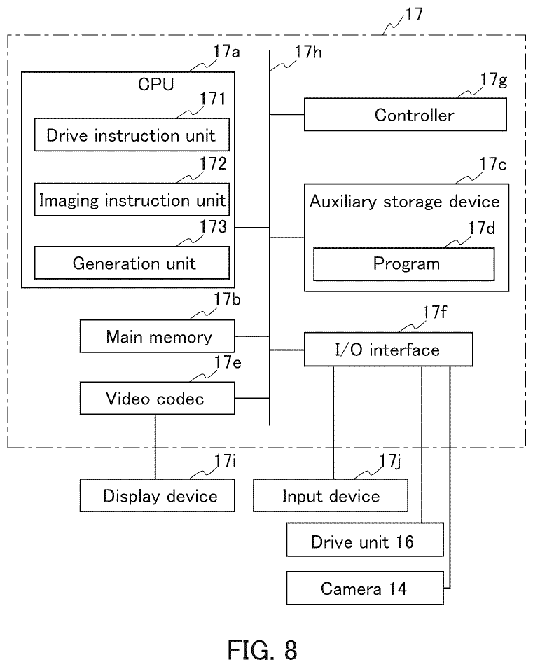

Next, the configuration of the control unit 17 is illustrated in FIG. 8. FIG. 8 is a block diagram illustrating an example of the configuration of the control unit 17. As illustrated in FIG. 8, the control unit 17 has a configuration similar to a personal computer, a server computer, a workstation, or the like.

The control unit 17 includes a central processing unit (CPU) 17a, a main memory 17b, an auxiliary storage device 17c, a video codec 17e, an input-output (I/O) interface 17e, a controller (such as a system controller or an I/O controller) 17g and a bus 17h.

The CPU 17a operates in cooperation with other components under the control of the controller 17g and is responsible for the overall control of the optical observation apparatus 600. In the optical observation apparatus 600, the CPU 17a executes a program 17d of the present disclosure and other programs, and reads and writes various types of information, for example. Specifically, the CPU 17a functions as a drive instruction unit 171, an imaging instruction unit 172, and a generation unit 173. Although the optical observation apparatus 600 includes the CPU 17a as an arithmetic unit, the optical observation apparatus 600 may include another arithmetic unit such as a graphics processing unit (GPU) or an accelerated processing unit (APU), or may further include such an arithmetic unit in combination with the CPU.

The main memory 17b is also referred to as a main storage device. When the CPU 17a executes processing, the main memory 17b reads various operation programs, including the program 17d of the present disclosure, stored in the auxiliary storage device 17c (auxiliary storage apparatus) to be described below, for example. Then, the CPU 17a reads out data from the main memory 17b, decodes the data, and executes the programs. The main memory is a random-access memory (RAM), for example. Examples of the main memory 17b further include a read-only memory (ROM).

The auxiliary storage device 17c stores the operation programs including the program 17d of the present disclosure. The auxiliary storage device 17c includes, for example, a storage medium and a drive for reading from and writing on the storage medium. The storage medium is not limited to particular types of storage media. The storage medium may be, for example, either a built-in or external storage medium, and examples thereof include a hard disk (HD), a Floppy (registered trademark) disk (FD), CD-ROM, CD-R, CD-RW, MO, DVD, a flash memory, and a memory card. The drive is not limited to particular types of drives. The auxiliary storage device 17c may be, for example, a hard disk drive (HDD) in which the storage medium and the drive are integrated.

The video codec 17e includes a graphics processing unit (GPU) that generates a screen to be displayed based on a drawing instruction received from the CPU 17a and transmits the screen signal to, for example, a display device 17i external to the optical observation apparatus 600 and the like, a video memory that temporarily stores the screen and image data, and the like.

The I/O interface 17f is a device that is communicably connected to the camera 14 and the drive unit 16 to control them or acquire information on images and the like. The I/O interface 17f may include a servo driver (servo controller). In addition, the I/O interface 17f may be connected to an input means (an input device 17j) external to the optical observation apparatus 600, for example. Examples of the input device 17j include a touch panel, track pad, pointing device such as a mouse, keyboard, and push button that can be operated by fingers of the user.

The bus 17h can also be connected to, for example, external equipment. Examples of the external equipment include an external storage device (such as an external database) and a printer. The optical observation apparatus 600 can be connected to a communication network through a communication device connected to the bus 17h and the like, for example, and can also be connected to the external equipment via the communication network. The communication network is not limited to particular types of networks, and known networks can be used. The communication network may be either wired or wireless, for example. The communication network may be, for example, an Internet network, the World Wide Web (WWW), a telephone network, a local area network (LAN), or a Wireless Fidelity (Wi-Fi).

Examples of the display device 17i include a monitor that outputs images (for example, various image display devices such as a liquid crystal display (LCD) and a cathode ray tube (CRT) display).

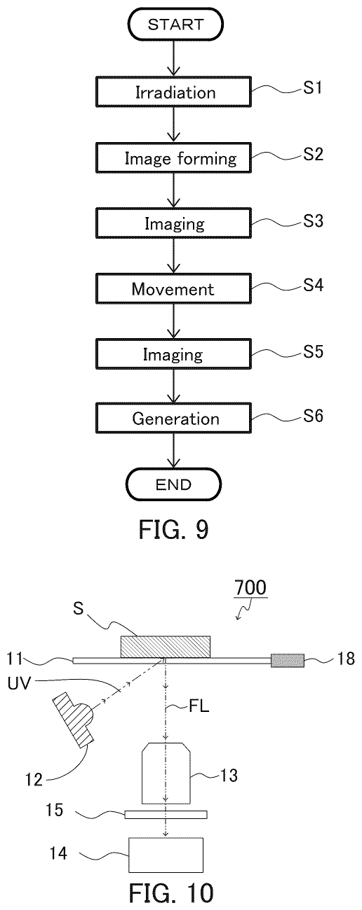

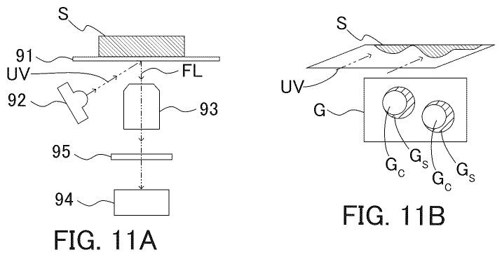

Next, an imaging method of the second embodiment using the optical observation apparatus 600 of the second embodiment will be described, using the FIGS. 7 to 9. FIG. 9 is a flowchart illustrating the imaging method of the second embodiment. As illustrated in FIG. 9, the imaging method of the second embodiment includes, in addition to steps in the imaging method of the first embodiment, step S4 (movement), step S5 (imaging), and step S6 (generation).

First, steps S1 to S3 are performed in the same manner as in the imaging method of the first embodiment, to take an observed image G1, as illustrated in FIG. 7E.

Next, in step S4, the position of the light source 12 is moved to acquire an observation image of the sample S irradiated with the ultraviolet light UV from the light source 12 arranged at a position (second position) different from the position (first position) of the light source 12 when the observation image G1 was taken in step S3. Specifically, in step S4, the light source 12 is moved rotationally by the drive unit 16, to take the observation image when the sample S is irradiated with the ultraviolet light UV from the light source 12 at a different position on the arc that includes the first position, centered around the optical axis of the objective lens 13. Specifically, the drive instruction unit 171 of the control unit 17 instructs the drive unit 16 to move the light source 12 from the position of the light source 12 in step S3 (first irradiation position) illustrated in FIG. 7B to the new position (second position) illustrated in FIG. 7D. The second position is a position different from the position where the light source 12 projects the ultraviolet light UV in step S3 (first position). In the imaging method of the present embodiment, the second position is a position located after moving substantially 180 degrees from the first position, along a circular path centered around the optical axis of the objective lens 13. However, the imaging method of the present disclosure is not limited thereto, and the second position may be a position located after moving rotationally at any angle, as long as the position is not the same position as the first position.

In step S5, the camera 14 takes an observation image G2 in a state where the light source 12 is arranged at the new irradiation position and the sample S is irradiated with the ultraviolet light UV from the light source 12 according to the instruction of the imaging instruction unit 172 of the control unit 17.

Next, in step S6, an observation image G3 in which shadows in the observation images G1 and G2 are reduced is generated using the observation image G1 taken in step S3 and the observation image G2 taken in step S5. The observation image G3 is generated from the observation images G1 and G2 through, for example, a method of integrating regions having the luminance not less than a threshold value in the observation images G1 and G2, a method of averaging all or a part of taken images including the observation images G1 and G2, a method of comparing the luminance of pixels with the same coordinates between a plurality of acquired images and generating an image using the maximum luminance values as the representative value of respective pixels, a method of comparing the luminance of pixels with the same coordinates and averaging the luminance after excluding the minimum luminance value of each pixel, or the like.

The imaging method of the second embodiment is then completed.

The optical observation apparatus 600 of the second embodiment takes the observation images G1 and G2 in a state where the sample S is irradiated with the ultraviolet light UV from the different positions of the light source 12, that is, from the first position and the second position. The observation images G1 and G2 differ in regions of shadows formed in the recessed portions caused by the irregularities on the sample S when the ultraviolet light UV is projected. For example, the region in shadow in the observation image G1 may not be in shadow in the observation image G2 as the region is irradiated with the ultraviolet light UV projected from the light source 12 at the second position, causing the observation light including the fluorescence FL to be emitted from the region. Thus, in the optical observation apparatus 600 of the second embodiment, the regions in shadow in the observation image G1 or the observation image G2 can be supplemented with each other by using the observation images G1 and G2, and thus the observation image in which generation of shadows caused by the irregularities on the sample is suppressed can be acquired.

Although in the optical observation apparatus 600, the light source 12 is arranged at the two positions to acquire the observation images of the sample S, the optical observation apparatus of the present disclosure may arrange the light source 12 at three or more different positions to acquire the observation images of the sample S and generate the observation image of the sample S using these observation images. The two or more different positions are preferably arranged at equal intervals on an arc around the optical axis as a central axis, for example.

### Modification of Second Embodiment

The optical observation apparatus of the present disclosure is not limited to the mode of the second embodiment, and can be modified in various ways. For example, an example of a case where, in the optical observation apparatus 600 of the second embodiment, the light source 12 is moved by the drive unit 16. However, the optical observation apparatus of the present disclosure is not limited to the example, and the position of the stage 11 relative to the light source 12 may be moved. Another example of a case where the stage 11 is moved by a drive unit 18 is illustrated in FIG. 10.

### Fifth Modification

FIG. 10 is a schematic view illustrating a configuration of an optical observation apparatus 700 of a fifth modification. As illustrated in FIG. 10, the optical observation apparatus 700 of the fifth modification includes the drive unit 18 that is capable of moving the stage 11, instead of the drive unit 16 for the light source 12 in the optical observation apparatus 600 of the second embodiment.

The drive unit 18 is capable of moving the position of the stage 11 rotationally centered around the optical axis of the objective lens 13. Accordingly, a similar effect can be obtained to the case where the light source 12 is moved to the second position to irradiate the observation position for the sample S with the ultraviolet light UV in the optical observation apparatus 600 of the second embodiment. For the drive unit 18, an XY stage as a configuration integrated with the stage 11 can be used, for example. For the drive unit 18, a combination of a rail and a carriage, a worm gear, a bearing, or the like can be used, for example.

Although the present disclosure has been described above with reference to the above-described embodiments, the present disclosure is not limited to the embodiments. Various changes and modifications that may become apparent to those skilled in the art may be made in the configuration and specifics of the present disclosure within the scope of the present disclosure.

### SUPPLEMENTARY NOTES

The whole or part of the exemplary embodiments and examples disclosed above can be described as, but not limited to, the following supplementary notes.

### <Optical Observation Apparatus>

### Supplementary Note 1

An optical observation apparatus including:
a placement unit configured to place a sample containing a cell;
a light source configured to irradiate the sample with ultraviolet light from at least two directions;
an imaging optical system configured to form an image of observation light emitted from the sample due to the ultraviolet light as an observation image; and
an imaging unit configured to take the observation image using an image sensor.

### Supplementary Note 2

The optical observation apparatus according to Supplementary Note 1, further including:
at least two light sources, wherein
a first light source and a second light source configured to irradiate the sample with ultraviolet light from two directions.

### Supplementary Note 3

The optical observation apparatus according to Supplementary Note 1 or 2, further including:
at least two light sources; and
an illumination optical system configured to guide ultraviolet light projected from a first light source and a second light source to the sample.

### Supplementary Note 4

The optical observation apparatus according to Supplementary Note 3, wherein
the illumination optical system includes a prism.

### Supplementary Note 5

The optical observation apparatus according to Supplementary Note 1, wherein
the light source is ring-shaped.

### Supplementary Note 6

The optical observation apparatus according to Supplementary Note 5, further including:
an illumination optical system configured to guide ultraviolet light projected from the light source that is ring-shaped to the sample.

### Supplementary Note 7

The optical observation apparatus according to Supplementary Note 6, wherein
the illumination optical system includes a mirror.

### Supplementary Note 8

The optical observation apparatus according to Supplementary Note 1, wherein
the light source is dome-shaped.

### Supplementary Note 9

The optical observation apparatus according to Supplementary Note 1, wherein
the light source includes a drive unit configured to move a position of the light source around an optical axis of the imaging optical system, and a control unit, and
the control unit is configured to drive the drive unit to control the position of the light source, take observation images at a first position and a second position that differ in a relative position of the light source to the sample, and generate an observation image of the sample based on the observation image at the first position and the observation image at the second position.

### Supplementary Note 10

The optical observation apparatus according to Supplementary Note 1, wherein
the placement unit includes a drive unit configured to move a position of the placement unit around an optical axis of the imaging optical system, and a control unit, and
the control unit is configured to drive the drive unit to control the position of the placement unit, take observation images at a first position and a second position that differ in a relative position of the light source to the sample, and generate an observation image of the sample based on the observation image at the first position and the observation image at the second position.

### Supplementary Note 11

The optical observation apparatus according to any one of Supplementary Notes 1 to 10, wherein
the ultraviolet light is incident on the sample at an acute angle with respect to a surface on which the sample is placed.

### Supplementary Note 12

The optical observation apparatus according to Supplementary Note 11, wherein
the ultraviolet light is incident on the sample at an angle of incidence of 10 to 50 degrees with respect to the surface on which the sample is placed.

### Supplementary Note 13

The optical observation apparatus according to any one of Supplementary Notes 1 to 12, further including:
a filter unit configured to change a wavelength region of observation light and transmits the changed observation light, wherein
the filter unit is arranged between the imaging optical system and the imaging unit.

### Supplementary Note 14

The optical observation apparatus according to Supplementary Note 13, wherein
the filter unit includes a bandpass filter or a superconducting transition-edge sensor.

### Supplementary Note 15

The optical observation apparatus according to Supplementary Note 13 or 14, wherein
the filter unit is configured to transmit light within a wavelength region ranging from 400 to 600 nm.

### Supplementary Note 16

The optical observation apparatus according to any one of Supplementary Notes 1 to 15, wherein
the imaging optical system includes an objective lens or a telecentric lens.

### Supplementary Note 17

The optical observation apparatus according to any one of Supplementary Notes 1 to 16, wherein
a wavelength region of the ultraviolet light ranges from 200 to 400 nm.

### Supplementary Note 18

The optical observation apparatus according to any one of Supplementary Notes 1 to 17, wherein
a wavelength region of the observation light ranges from 400 to 600 nm.

### Supplementary Note 19

The optical observation apparatus according to any one of Supplementary Notes 1 to 18, wherein
the cell is stained with a fluorescent dye that can be excited by the ultraviolet light.

### <Imaging Method>

### Supplementary Note 20

An imaging method used in an optical observation apparatus that includes a placement unit, a light source, an imaging optical system, and an imaging unit, the imaging method including:
irradiating a sample containing a cell that is placed on the placement unit with ultraviolet light projected from the light source from at least two directions;
forming an image of observation light emitted from the sample due to the ultraviolet light as an observation image using the imaging optical system; and
taking the observation image using an image sensor of the imaging unit.

### Supplementary Note 21

The imaging method according to Supplementary Note 20, wherein
the optical observation apparatus includes at least two light sources, and
the irradiating is irradiating the sample with ultraviolet light from two directions using a first light source and a second light source.

### Supplementary Note 22

The imaging method according to Supplementary Note 20 or 21, wherein
the optical observation apparatus includes at least two light sources and an illumination optical system, and
the irradiating is irradiating the sample with ultraviolet light projected from a first light source and a second light source via the illumination optical system.

### Supplementary Note 23

The imaging method according to Supplementary Note 22, wherein
the illumination optical system includes a prism.

### Supplementary Note 24

The imaging method according to Supplementary Note 20, wherein
the light source is ring-shaped.

### Supplementary Note 25

The imaging method according to Supplementary Note 24, wherein
the optical observation apparatus includes an illumination optical system, and
the irradiating is irradiating the sample with ultraviolet light projected from the light source that is ring-shaped via the illumination optical system.

### Supplementary Note 26

The imaging method according to Supplementary Note 25, wherein
the illumination optical system includes a mirror.

### Supplementary Note 27

The imaging method according to Supplementary Note 20, wherein
the light source is dome-shaped.

### Supplementary Note 28

The imaging method according to Supplementary Note 20, wherein
the light source includes a drive unit, and
the taking comprises driving the drive unit to control a position of the light source and moving the position of the light source around an optical axis of the imaging optical system, and taking observation images at a first position and a second position that differ in a relative position of the light source to the sample, and
the method further comprising:
generating an observation image of the sample based on the observation image at the first position and the observation image at the second position.

### Supplementary Note 29

The imaging method according to Supplementary Note 20, wherein
the placement unit includes a drive unit capable of moving the placement unit, and
   the taking comprises driving the drive unit to control a position of the placement unit and moving the position of the placement unit around an optical axis of the imaging optical system, and taking observation images at a first position and a second position that differ in a relative position of the light source to the sample, and
the method further comprising:
generating an observation image of the sample based on the observation image at the first position and the observation image at the second position.

### Supplementary Note 30

The imaging method according to any one of Supplementary Notes 20 to 29, wherein
the ultraviolet light is incident on the sample at an acute angle with respect to a surface on which the sample is placed.

### Supplementary Note 31

The imaging method according to any one of Supplementary Notes 20 to 30, wherein
the ultraviolet light is incident on the sample at an angle of incidence of 10 to 50 degrees with respect to the surface on which the sample is placed.

### Supplementary Note 32

The imaging method according to any one of Supplementary Notes 20 to 31, wherein
the optical observation apparatus includes a filter unit, and
the taking comprises changing a wavelength region of the observation light transmitted through the imaging optical system by passing through the filter unit, and forming an image of the changed observation light as the observation image.

### Supplementary Note 33

The imaging method according to Supplementary Note 32, wherein
the filter unit includes a bandpass filter or a superconducting transition-edge sensor.

### Supplementary Note 34

The imaging method according to Supplementary Note 32 or 33, wherein
the filter unit transmits light within a wavelength region ranging from 400 to 600 nm.

### Supplementary Note 35

The imaging method according to any one of Supplementary Notes 26 to 30, wherein
the imaging optical system includes an objective lens,
the irradiating comprises projecting ultraviolet light reflected from the illumination optical system passes through the objective lens to the sample, and
the taking comprises forming an image of the observation light as the observation image by the objective lens.

### Supplementary Note 36

The imaging method according to any one of Supplementary Notes 20 to 35, wherein
the imaging optical system includes an objective lens or a telecentric lens.

### Supplementary Note 37

The imaging method according to any one of Supplementary Notes 20 to 36, wherein
a wavelength region of the ultraviolet light ranges from 200 to 400 nm.

### Supplementary Note 38

The imaging method according to any one of Supplementary Notes 20 to 37, wherein
a wavelength region of the observation light ranges from 400 to 600 nm.

### Supplementary Note 39

The imaging method according to any one of Supplementary Notes 20 to 38, wherein
the cell is stained with a fluorescent dye that can be excited by the ultraviolet light.

### REFERENCE SIGNS LIST

11 stage
12 light source
13 objective lens
14 camera
15 bandpass filter
16, 18 drive unit
17 control unit
171 drive instruction unit
172 imaging instruction unit
173 generation unit
17a CPU
17b main memory
17c auxiliary storage device
17d program
17e video codec
17f I/O interface
17g controller
17h bus
17i display device
17j input device
100, 200, 300, 400, 500, 600, 700 optical observation apparatus

1. An optical observation apparatus comprising:
a stage configured to place a sample containing a cell;
a light source configured to irradiate the sample with ultraviolet light from at least two directions;
an imaging optical system configured to form an image of observation light emitted from the sample due to the ultraviolet light as an observation image; and
an imager configured to take the observation image using an image sensor.

2. The optical observation apparatus according to claim 1, further comprising:
at least two light sources, wherein
a first light source and a second light source is configured to irradiate the sample with ultraviolet light from two directions.

3. The optical observation apparatus according to claim 2, further comprising:
an illumination optical system configured to guide ultraviolet light projected from the first light source and the second light source to the sample.

4. The optical observation apparatus according to claim 3, wherein
the illumination optical system comprises a prism.

5. The optical observation apparatus according to claim 1, wherein
the light source is ring-shaped.

6. The optical observation apparatus according to claim 5, further comprising:
an illumination optical system configured to guide ultraviolet light projected from the light source that is ring-shaped to the sample.

7. The optical observation apparatus according to claim 6, wherein
the illumination optical system comprises a mirror.

8. The optical observation apparatus according to claim 1, wherein
the light source is dome-shaped.

9. The optical observation apparatus according to claim 1, wherein
the light source comprises a driver configured to move a position of the light source around an optical axis of the imaging optical system, and a controller, and
the controller is configured to drive the driver to control the position of the light source, take observation images at a first position and a second position that differ in a relative position of the light source to the sample, and generate an observation image of the sample based on the observation image at the first position and the observation image at the second position.

10. The optical observation apparatus according to claim 1, wherein
the stage comprises a driver configured to drive a position of the placement unit around an optical axis of the imaging optical system, and a control unit, and
the controller is configured to drive the driver to control the position of the placement unit, take observation images at a first position and a second position that differ in a relative position of the light source to the sample, and generate an observation image of the sample based on the observation image at the first position and the observation image at the second position.

11. The optical observation apparatus according to claim 1, wherein
the ultraviolet light is incident on the sample at an acute angle with respect to a surface on which the sample is placed.

12. The optical observation apparatus according to claim 11, wherein
the ultraviolet light is incident on the sample at an angle of incidence of 10 to 50 degrees with respect to the surface on which the sample is placed.

13. The optical observation apparatus according to claim 1, further comprising:
a filter configured to change a wavelength region of the observation light and transmit the changed observation light, wherein
the filter is arranged between the imaging optical system and the imager.

14. The optical observation apparatus according to claim 13, wherein
the filter comprises a bandpass filter or a superconducting transition-edge sensor.

15. The optical observation apparatus according to claim 14, wherein
the filter is configured to transmit light within a wavelength region ranging from 400 to 600 nm.

16. The optical observation apparatus according to claim 1, wherein
the imaging optical system comprises an objective lens or a telecentric lens.

17. The optical observation apparatus according to claim 1, wherein
a wavelength region of the ultraviolet light ranges from 200 to 400 nm.

18. The optical observation apparatus according to claim 1, wherein
a wavelength region of the observation light ranges from 400 to 600 nm.

19. The optical observation apparatus according to claim 1, wherein
the cell is stained with a fluorescent dye excited by the ultraviolet light.

20. An imaging method for use in an optical observation apparatus that comprises a stage, a light source, an imaging optical system, and an imager, the method comprising:
irradiating a sample containing a cell that is placed on the placement unit with ultraviolet light projected from the light source from at least two directions;
forming an image of observation light emitted from the sample due to the ultraviolet light as an observation image using the imaging optical system; and
taking the observation image using an image sensor of the imager.
